(19) United States
(12) Patent Application Publication
(10) Pub. No.: US 2007/0061406 A1
(43) Pub. Date: Mar. 15, 2007

(54) Home network system

(76) Inventors: Seung-Myun Baek, Kyungsangnam-do (KR); Koon-Seok Lee, Kyungsangnam-do (KR); Hwan-Jong Choi, Busan (KR); Yong-Tae Kim, Kyungsangnam-do (KR); Feel-Young Koo, Busan (KR); Ja-In Koo, Kyungsangnam-do (KR); Seong-Hwan Kang, Kyungsangnam-do (KR)

Correspondence Address: MCKENNA LONG & ALDRIDGE LLP, 1900 K STREET, NW, WASHINGTON, DC, 20006, US

(21) Appl. No.: 10/558,428

(22) PCT Filed: Jan. 20, 2004
(86) PCT No.: PCT/KR04/00103

§ 371 Date: Sep. 25, 2006

(30) Foreign Application Priority Data
May 30, 2003 (KR) 10-2003-0034962

(51) Int. Cl. G06F 15/16

(52) U.S. Cl. 709/208

(57) ABSTRACT

The present invention discloses a home network system (100) which can easily control home appliances by performing a preset control command for a predetermined event when the event is generated. The home network system (100) includes at least one slave device (60), and a master device (50) connected to the slave devices (60) through a predetermined network (90). The master device (50) stores an event file including an externally-inputted generation condition of a predetermined event and a control command for the event, and transmits an event set file including at least the generation condition of the event to the slave device (60) corresponding to the generation condition of the event, and the slave device (60) stores the event set file and transmits an event notification file to the master device (50) when the event is generated, so that the master device (50) can receive the event notification file and make the corresponding control command performed.

### TECHNICAL FIELD

The present invention relates to a home network system, and more particularly to, a home network system which can easily control home appliances by performing a preset control command for a predetermined event when the event is generated.

### BACKGROUND ART

Home automation for automatically controlling home appliances at home or remotely has almost reached a commercial use stage. At its early stage, the home automaton separately controlled each home appliance by using a telephone or infrared rays, and did not connect the home appliances. However, there has been suggested a method for building a network of home appliances by using a communication means, and collectively managing the network by using a controller.

FIG. 1 is a structure view illustrating a general home network system. Referring to FIG. 1, a home network connects various digital home appliances so that a user can always enjoy convenient, safe and economical life services inside or outside the house.

As factors of the advent of the home network, refrigerators or washing machines called white home appliances have been gradually digitalized due to development of digital signal processing techniques, and new information home appliances have been made due to rapid development of home appliance operating system techniques and high speed multimedia communication techniques.

Here, an IT network is built to exchange data between a personal computer and peripheral devices or provide internet services, and an AV network is built between home appliances using audio or video information. In addition, a living network is built to simply control home appliances, such as home automation or remote meter reading, and may be comprised of a refrigerator, washing machine, microwave oven, electric lamp, gas alarm, air conditioner and telephone.

The home network system includes a master device which is a home appliance for controlling an operation of the other home appliances or monitoring a status thereof, and a slave device which is a home appliance having a function of responding to the request of the master device and a function of notifying a status change according to properties of the home appliances or other factors. Here, the home appliances (or new devices) include home appliances for the living network service such as a washing machine and a refrigerator as well as home appliances for the IT network service and the AV network service.

FIG. 2 is a structure view illustrating a general home network system in a house. As illustrated in FIG. 2, the home network system 1 in the house includes at least one master device 10 and slave device 1 to 4 20, 22, 24 and 26 connected through a bus network 28.

In the conventional home network system 1, the master device 10 receives a control command from the user and transmits the control command to the corresponding slave device 1 to 4 20, 22, 24 and 26, or receives a notification message for generation of a predetermined event from each slave device 1 to 4 20, 22, 24 and 26, and displays generation of the event to the user. When the master device 10 does not receive the control command from the user, the master device 10 does not transmit the control command to each slave device 1 to 4 20, 22, 24 and 26, or perform its own control command.

However, in case a predetermined event is generated, the conventional home network system 1 cannot simultaneously or sequentially control the plurality of master devices 10 and/or slave devices 1 to 4 20, 22, 24 and 26 relating to the event. Accordingly, the user must input control commands for each of the plurality of master devices 10 and/or slave devices 1 to 4 20, 22, 24 and 26.

In addition, the conventional home network system 1 does not control an interval of notification messages for generation of events from the plurality of master devices 10 and/or slave devices 1 to 4 20, 22, 24 and 26. In the case that a lot of notification messages are transmitted through the bus network 28 at the same time, network efficiency is reduced due to congestion.

### DISCLOSURE OF THE INVENTION

An object of the present invention is to provide a home network system which can simultaneously or sequentially perform a series of control commands which are wanted by the user or beneficial to the system, when a predetermined event is generated.

Another object of the present invention is to provide a home network system which can efficiently perform network communication by controlling an interval of transmission of notification messages for events through a bus network, when the plurality of events are generated.

Yet another object of the present invention is to provide a home network system which can smoothly perform network communication by setting and controlling a frequency of notifications of an event according to properties of the event or upon the user's request.

In order to achieve the above-described objects of the invention, there is provided a home network system including: at least one slave device; and a master device connected to the slave devices through a predetermined network, wherein the master device stores an event file including an externally-inputted generation condition of a predetermined event and a control command for the event, and transmits an event set file including at least the generation condition of the event to the slave device corresponding to the generation condition of the event, and the slave device stores the event set file and transmits an event notification file to the master device when the event is generated, so that the master device can receive the event notification file and make the corresponding control command performed.

Preferably, the event file includes an identification code of a device for performing the control command.

Preferably, when the device for performing the control command is the master device, the master device performs the control command when receiving the event notification file.

Preferably, when the device for performing the control command is the slave device, the master device transmits the control command to the slave device, and the slave device performs the control command.

Preferably, the event file further includes an identification code of a device for deciding generation of the event.

Preferably, the generation condition of the event includes an event code and a status value.

Preferably, the event file includes a field of a time interval of generation of an event which notifies a time interval of transmission of the event notification file.

Preferably, the event file includes a field of a communication frequency which notifies a transmission frequency of the event notification file.

Preferably, the master device confirms a spare space of a nonvolatile memory of the slave device.

Preferably, when the nonvolatile memory of the slave device does not have a spare space, the master device transmits a file deletion command to the slave device so that the nonvolatile memory of the slave device can obtain the spare space, and transmits the event set file to the slave device.

Preferably, the event file and the event set file further include a time interval of generation of a predetermined size of event, so that the slave device can confirm a status of the network and transmit the event notification file to the master device at the time interval of generation of the event.

According to one aspect of the invention, a home network system includes: at least first and second home appliances; and a master device connected to the first and second home appliances through a predetermined network, wherein the master device stores an event file including an externally-inputted generation condition of a predetermined event and a control command for the event, and transmits the event file to the first home appliance corresponding to the generation condition of the event, and the first home appliance stores the event file and makes the control command performed when the event is generated.

According to another aspect of the invention, in a storage medium for storing an event file of a home network system, the event file used in the home network system comprised of at least two home appliances includes: a generation condition of an event, an identification code of the home appliance for performing a control command based on generation of the event, and the control command.

Preferably, the event file includes an event file header having a number of event codes for notifying the event and the event codes in the generation condition, and an event file body having a status value, the identification code of the home appliance and the control command in the generation condition.

Preferably, the event file further includes an identification code of a home appliance for deciding generation of the event.

Preferably, the event body further includes a field of a time interval of generation of the event.

Preferably, the event body further includes a field of a communication frequency.

### BRIEF DESCRIPTION OF THE DRAWINGS

The present invention will become better understood with reference to the accompanying drawings which are given only by way of illustration and thus are not limitative of the present invention, wherein:

FIG. 1 is a structure view illustrating a general home network system;

FIG. 2 is a structure view illustrating a general home network system in a house;

FIG. 3 is a structure view illustrating a home network system in accordance with a first embodiment of the present invention;

FIG. 4A is a structure view illustrating a header of an event file;

FIG. 4B is a structure view illustrating a body of an event file; and

FIG. 5 is a structure view illustrating a home network system in accordance with a second embodiment of the present invention.

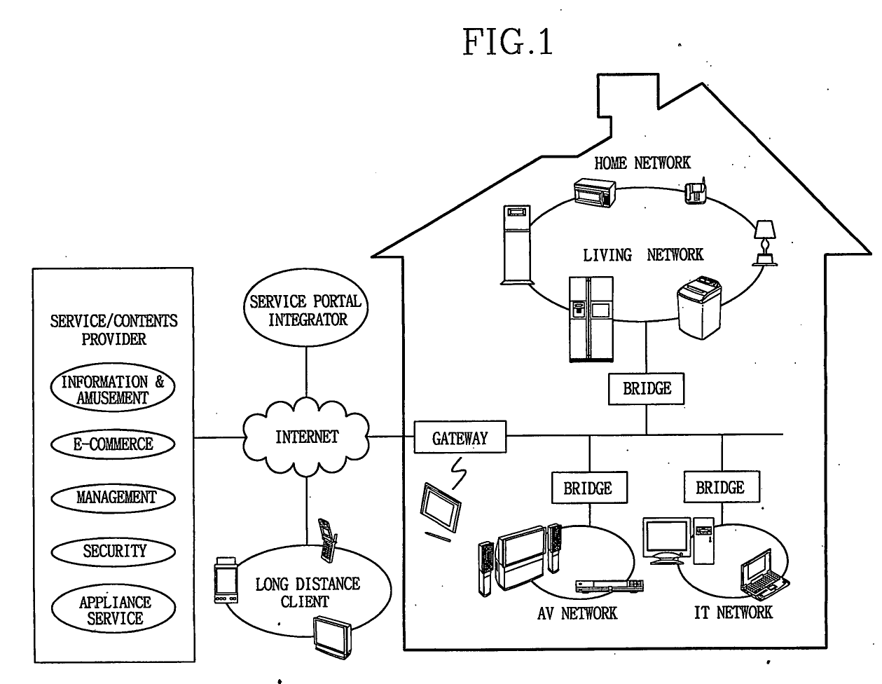

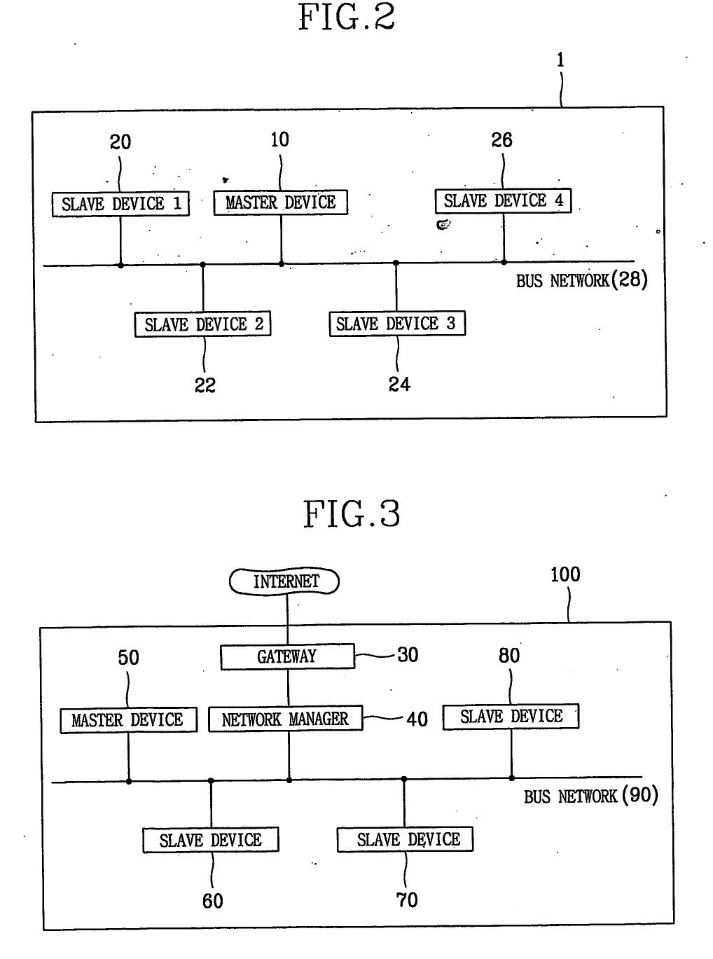

### BEST MODE FOR CARRYING OUT THE INVENTION

A home network system in accordance with the present invention will now be described in detail with reference to the accompanying drawings.

FIG. 3 is a structure view illustrating a home network system in accordance with a first embodiment of the present invention. Referring to FIG. 3, the home network system 100 includes at least one master device 50 and slave device 60, 70 and 80 connected through a bus network 90. The home network system 100 further includes a gateway 30 for access to an external network, and a network manager 40 connected to the gateway 30, for providing an internet service and performing environment setting and resetting functions of home appliances in the home network system 100.

Here, the master device 50 performs the same functions as the general master device, and the network manager 40 performs similar functions to the master device 50 except for the internet service. For conveniences' sake, there are presumed that the network manager 40 performs functions such as a bridge for the internet service, and that only one master device 50 exists in the home network system 100.

The bus network 90 can be a wire medium such as a specially-installed line, or a previously-installed power line or telephone line, or a wireless transmission medium. However, still referring to FIG. 3, the home network system 100 composes a closed network for connecting home appliances of one house through a wire or wireless transmission medium. At this time, the closed network includes a physically-connected but logically-divided network.

To perform a control command for a predetermined event when the event is generated, the master device 50 stores an event file inputted from the user through a user interface in a nonvolatile memory.

The event file includes at least a generation condition of an event, a control command performed when the event is generated, and an identification code for notifying a device for performing the control command (master device 50 or slave device 60, 70 or 80). In addition, the master device 50 can process an event file including an identification code for notifying a device for deciding a generation condition (master device 50 or slave device 60, 70 or 80), or decides a generation condition of an event, searches a device corresponding to the generation condition, and processes an event file.

It is presumed that the user or producer inputs the contents of the event file, such as ‘display washing completion after finishing washing’ or ‘start cooling when room temperature is over 30° C.’ to the master device 50 through the user interface.

Here, the generation condition of the event is the generation or modification time of the status, such as ‘after finishing washing’ or ‘when room temperature is over 30° C.’. Therefore, the generation condition of the event can include an event code implying the event itself such as ‘after washing’, or an event code such as ‘when room temperature is over 30° C.’ (namely, room temperature) and a status value (namely, over 30° C.).

The device for deciding the generation condition of the event can be a washing machine in the event of ‘after washing’, and a thermometer or air conditioner in the event of ‘when room temperature is over 30° C.’. As described above, the device for deciding the generation condition of the event is the device corresponding to the event and the generation condition of the event (master device 50 or slave device 60, 70 or 80). Accordingly, the master device 50 can determine the device for deciding the generation condition of the event according to the event and the generation condition of the event, or identify the device for deciding the generation condition of the event according to the identification code of the device included in the event file.

The control command is a concrete command such as ‘display washing completion’ or ‘start cooling’.

The device for performing the control command can be a refrigerator having a television or monitor in the event of ‘display washing completion’, and an air conditioner in the event of ‘start cooling’. That is, the device for performing the control command is the device whose function essentially relates to the control command (master device 50 or slave device 60, 70 or 80).

Here, the master device 50 transmits an event set file including at least the generation condition of the event (event code and/or status value) to the slave device 60, 70 or 80 for deciding the generation condition of the event according to the stored event file. The slave device 60, 70 or 80 stores the event set file in its nonvolatile memory.

When the event is generated, the slave device 60, 70 or 80 transmits an event notification file to the master device 50, and the master device 50 receives the event notification file and makes a control command performed, which corresponds to the generation condition of the event included in the event notification file. The control command can be executed by the master device 50 or slave device 60, 70 or 80. If the device for performing the control command is the master device 50, the master device 50 performs the control command. If the device for performing the control command is the slave device 60, 70 or 80, the master device 50 transmits the control command to the slave device 60, 70 or 80, so that the slave device 60, 70 or 80 can perform the control command.

When the master device 50 transmits the event set file to the slave device 60, 70 or 80 which is the device for deciding the event corresponding to the event code, the master device 50 confirms in advance whether the built-in nonvolatile memory of the slave device 60, 70 or 80 has a spare space. When the nonvolatile memory has the spare space for storing the event set file, the master device 50 transmits the event set file to the slave device 60, 70 or 80. If the nonvolatile memory of the slave device 60, 70 or 80 does not have a spare space for storing the event set file, the master device 50 transmits a file deletion command to the slave device 60, 70 or 80. The slave device 60, 70 or 80 obtains a space corresponding to the event set file by deleting unnecessary files in the nonvolatile memory and transmits a notification message to the master device 50, and the master device 50 transmits the event set file.

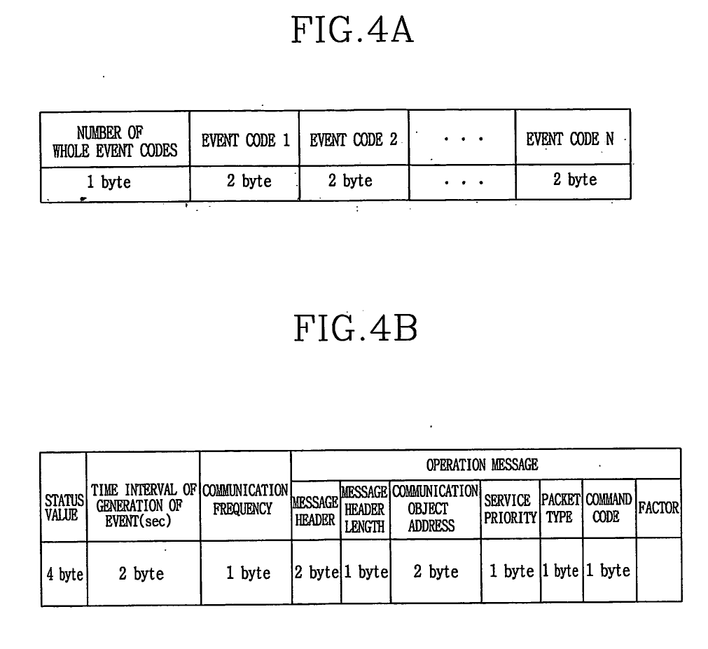

FIG. 4A is a structure view illustrating a header of the event file. As shown in FIG. 4A, the header of the event file includes fields of a number of the whole event codes and each event code 1 to N.

FIG. 4B is a structure view illustrating a body of the event file. As depicted in FIG. 4B, the body of the event file includes fields of a status value, a time interval of generation of an event, a communication frequency and an operation message.

The field of the status value has been described above, and the field of the time interval of generation of the event implies the time interval at which the device for deciding generation of the event transmits the event notification file through the bus network 90 when the event is generated. When the bus network 90 is usable, the event notification file is transmitted through the bus network 90. For example, if a temperature or sensor status of the event is rapidly varied, a plurality of event notification files are transmitted through the bus network 90, which deteriorates performance of the bus network 90. To solve the foregoing problem, a minimum interval of generation of the event is required.

The field of the communication frequency means a frequency of repeatedly transmitting the event notification file. When a predetermined status is varied, an event is generated. If the generated event is maintained, the device for deciding the event does not transmit the event notification file any more. For example, when a door of a washing machine is opened during dehydration, the washing machine constantly displays an error status. However, the event for the door is generated once. Although the event has been generated once, if the current status needs to be constantly notified, the device for deciding the event repeatedly transmits the event notification file for the same event as often as the communication frequency.

Fields of a message header and a message header length are similar to those of a general message.

A field of a communication object address implies an identification code for notifying a device for performing a command code (control command) included in the operation message. That is, when the master device 50 receives the event notification file, the master device 50 transmits the command code to the field of the communication object address.

In addition, a field of service priority implies priority when a plurality of command codes based on generation of a plurality of events are transmitted to the field of the communication object address.

A field of a command code includes the control command, and a factor implies a factor for performing the control command.

On the basis of the event file, the master device 50 must transmit the event set file including at least the event code, the status value, the time interval of generation of the event and the communication frequency to the device for deciding the event corresponding to the event code.

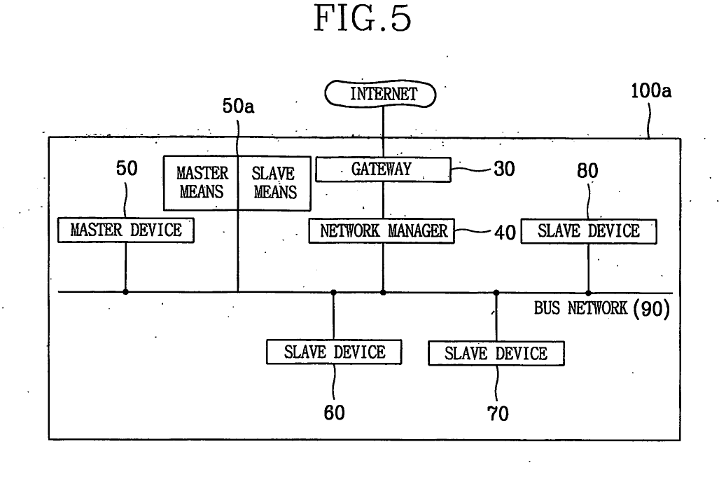

FIG. 5 is a structure view illustrating a home network system in accordance with a second embodiment of the present invention. Referring to FIG. 5, the home network system 100a includes elements having the same reference numerals as those of the home network system 100 of FIG. 3, and further includes a hybrid device 50a.

The hybrid device 50a is comprised of a master means operated in the same manner as the master device 50 and a slave means operated in the same manner as the slave devices 60, 70 and 80. The hybrid device 50a is physically one device but logically the master means and the slave means.

Here, the master device 50 transmits the event set file having the event code corresponding to the hybrid device 50a to the hybrid device 50a. Here, the event set file includes the fields of the event code, the status value, the time interval of generation of the event, the communication frequency and the operation message, and is almost identical to the event file for the specific event code.

The hybrid device 50a stores the event set file in the nonvolatile memory. When the event corresponding to the event code and the status value is generated; the hybrid device 50a confirms the stored field of the communication object address in the field of the operation message. When the device in the field of the communication object address is the hybrid device 50a, the hybrid device 50a directly performs the control command included in the field of the command code. When the device in the field of the communication object address is the slave device 60, 70 or 80, the hybrid device 50a transmits the control command (including the factor) to the slave device 60, 70 or 80 corresponding to the communication object address, so that the slave device 60, 70 or 80 can perform the control command.

The event file described above can be stored in the master device 50 in production by the producer of the home network system 100 or 100a, but mostly directly set or deleted by the user of the home network system 100 or 100a. Therefore, the master device 50 provides a user interface for setting by the user.

In addition, when the user changes the status value for the same event code, the communication object (namely, device for performing the control command) or the control command or factor, before/after the master device 50 transmits the event file and/or event set file including such changes, the master device 50 transmits a deletion command for the previously-stored event file and/or event set file to the slave device 60, 70 or 80 and/or the hybrid device 50a.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A home network system, comprising:
at least one slave device; and
a master device connected to the slave devices through a predetermined network,
wherein the master device stores an event file including an externally-inputted generation condition of a predetermined event and a control command for the event, and transmits an event set file including at least the generation condition of the event to the slave device corresponding to the generation condition of the event, and the slave device stores the event set file and transmits an event notification file to the master device when the event is generated, so that the master device can receive the event notification file and make the corresponding control command performed.

2. The home network system of claim 1, wherein the event file comprises an identification code of a device for performing the control command.

3. The home network system of claim 2, wherein, when the device for performing the control command is the master device, the master device performs the control command when receiving the event notification file.

4. The home network system of claim 2, wherein, when the device for performing the control command is the slave device, the master device transmits the control command to the slave device, and the slave device performs the control command.

5. The home network system of claim 2, wherein the event file further comprises an identification code of a device for deciding generation of the event.

6. The home network system of claim 1, wherein the generation condition of the event comprises an event code and a status value.

7. The home network system of claim 1, wherein the event file comprises a field of a time interval of generation of an event which notifies a time interval of transmission of the event notification file.

8. The home network system of claim 1, wherein the event file comprises a field of a communication frequency which notifies a transmission frequency of the event notification file.

9. The home network system of claim 1, wherein the master device confirms a spare space of a nonvolatile memory of the slave device.

10. The home network system of claim 9, wherein, when the nonvolatile memory of the slave device does not have a spare space, the master device transmits a file deletion command to the slave device so that the nonvolatile memory of the slave device can obtain the spare space, and transmits the event set file to the slave device.

11. The home network system of either claim 2 or 3, wherein the event file and the event set file further comprise a time interval of generation of a predetermined size of event, so that the slave device can confirm a status of the network and transmit the event notification file to the master device at the time interval of generation of the event.

12. A home network system, comprising:
at least first and second home appliances; and
a master device connected to the first and second home appliances through a predetermined network,
wherein the master device stores an event file including an externally-inputted generation condition of a predetermined event and a control command for the event, and transmits the event file to the first home appliance corresponding to the generation condition of the event, and the first home appliance stores the event file and makes the control command performed when the event is generated.

13. The home network system of claim 12, wherein the event file comprises an identification code of a home appliance for performing the control command.

14. The home network system of claim 13, wherein when the home appliance for performing the control command is the first home appliance, the first home appliance performs the control command when receiving the event notification file.

15. The home network system of claim 13, wherein, when the home appliance for performing the control command is the second home appliance, the first home appliance transmits the control command to the second home appliance, and the second home appliance performs the control command.

16. The home network system of claim 13, wherein the event file further comprises an identification code of a home appliance for deciding generation of the event.

17. The home network system of claim 12, wherein the generation condition of the event comprises an event code and a status value.

18. The home network system of claim 12, wherein the event file comprises a field of a time interval of generation of an event which notifies a time interval of transmission of the event notification file.

19. The home network system of claim 12, wherein the event file comprises a field of a communication frequency which notifies a transmission frequency of the event notification file.

20. The home network system of claim 12, wherein the master device confirms a spare space of a nonvolatile memory of the first home appliance.

21. The home network system of claim 20, wherein, when the nonvolatile memory of the first home appliance does not have a spare space, the master device transmits a file deletion command to the first home appliance so that the nonvolatile memory of the first home appliance can obtain the spare space, and transmits the event set file to the first home appliance.

22. The home network system of either claim 12 or 13, wherein the event file further comprises a time interval of generation of a predetermined size of event, so that the first home appliance can confirm a status of the network and transmit the control command to the second home appliance at the time interval of generation of the event.

23. A storage medium for storing an event file of a home network system, the event file used in the home network system including at least two home appliances, comprising a generation condition of an event, an identification code of the home appliance for performing a control command based on generation of the event, and the control command.

24. The storage medium of claim 23, wherein the event file comprises an event file header having a number of event codes for notifying the event and the event codes in the generation condition, and an event file body having a status value, the identification code of the home appliance and the control command in the generation condition.

25. The storage medium of either claim 23 or 24, wherein the event file further comprises an identification code of a home appliance for deciding generation of the event.

26. The storage medium of claim 24, wherein the event body further comprises a field of a time interval of generation of the event.

27. The storage medium of claim 24, wherein the event body further comprises a field of a communication frequency.
